(19) United States
(12) Patent Application Publication
(10) Pub. No.: US 2007/0023461 A1
(43) Pub. Date: Feb. 1, 2007

(54) Flow controls for containers of liquids and viscous materials

(75) Inventors: Allen B. Christian, Garden Grove, CA (US); Robert K. Harr, Santa Ana, CA (US)

Correspondence Address: WILLIE KRAWITZ, 3001 CHAPEL HILL ROAD, ORANGE, CA, 92867-1927, US

(73) Assignee: CHRISHARR TECHNOLOGIES, INC.

(21) Appl. No.: 11/195,472

(22) Filed: Aug. 1, 2005

(51) Int. Cl. B67D 3/00

(52) U.S. Cl. 222/479

(57) ABSTRACT

A flow control device for containers of liquid and viscous materials include an air vent by-pass positioned within the container and extending into an enlarged area of the container. The flow control device enables a more smooth and uniform pouring of low viscosity liquids and viscous materials, and reduces or eliminates the intermittent flow associated with prior art containers for these materials. The invention is particularly useful when disposed within a hollow handle. Operation of the by-pass device may be augmented by a closure orifice positioned near the top of the container. Alternatively, the closure orifice may be used by itself for smaller container sizes, but with less flow control effect.

### BACKGROUND OF THE INVENTION

This invention relates to a new and improved flow control device to provide a uniform discharge of low viscosity liquids and viscous materials from containers. Typical liquids include foods, milk, juices, soaps, cleaning materials, etc.; viscous materials include ketchup, mustard, molasses, honey, gear and motor oils, pharmaceuticals, etc.

Numerous publications have disclosed flow control devices of the present type, and typical publications include U.S. Pat. Nos. 3,856,187; 4,493,709; 4,445,620; 4,838,464; 5,346,106; 5,634,504; 5,791,539; US 2004/0069799 A1; and, U.S. Pat. No. 6,206,251 B1; and, Japanese Patent JP 406,255,651 A. However, the devices shown in these patents tend to be complicated and generally do not fulfill their intended function. While many of the above devices may fulfill a uniform pouring function, they do so only when slowly poured.

### THE INVENTION

According to the invention, a control pouring device for a liquid container is provided comprising a container defining an air intake channel adjacent the pouring mouth of the container and separated therefrom. Typically, a closure orifice is defined in the air intake channel. In still another embodiment of the invention, the air intake channel is contained within or adjacent to a hollow handle of the container.

### BRIEF DESCRIPTION OF THE DRAWINGS

FIG. 1 is a perspective view of a container according to the invention showing an air intake orifice provided with an air closure element, the intake orifice being defined adjacent to a hollow handle and to a pouring mouth of the container;

FIGS. 2, 3 and 4 illustrate the air intake orifice and closure element therefor being positioned on the container;

FIG. 5 is a sectional view in side elevation showing an air intake channel coextensive with a hollow handle, an air relief bore and associated closure element, the entrance of the intake channel being somewhat remote from the exit of the pouring spout of the container;

FIG. 6 is a sectional view in side elevation showing an air intake channel coextensive with a hollow handle, air relief bore and closure element therefor, the entrance of the intake channel being adjacent the exit of the pouring spout of the container;

FIG. 7 is a sectional view in side elevation showing an air intake channel, the entrance to the intake channel being adjacent to the exit of the pouring spout of the container;

FIG. 8 is a sectional view in side elevation showing a closure element for an air intake channel, air relief bore and closure element therefor, similar to FIG. 7;

FIGS. 9 and 10 are perspective views of an air intake channel and closure element therefor suitable for use in the embodiments shown in FIGS. 1-4; and,

FIG. 11 is a perspective view of a container of the prior art showing an air intake channel remote from the pouring spout of the container.

### DESCRIPTION OF THE PREFERRED EMBODIMENTS

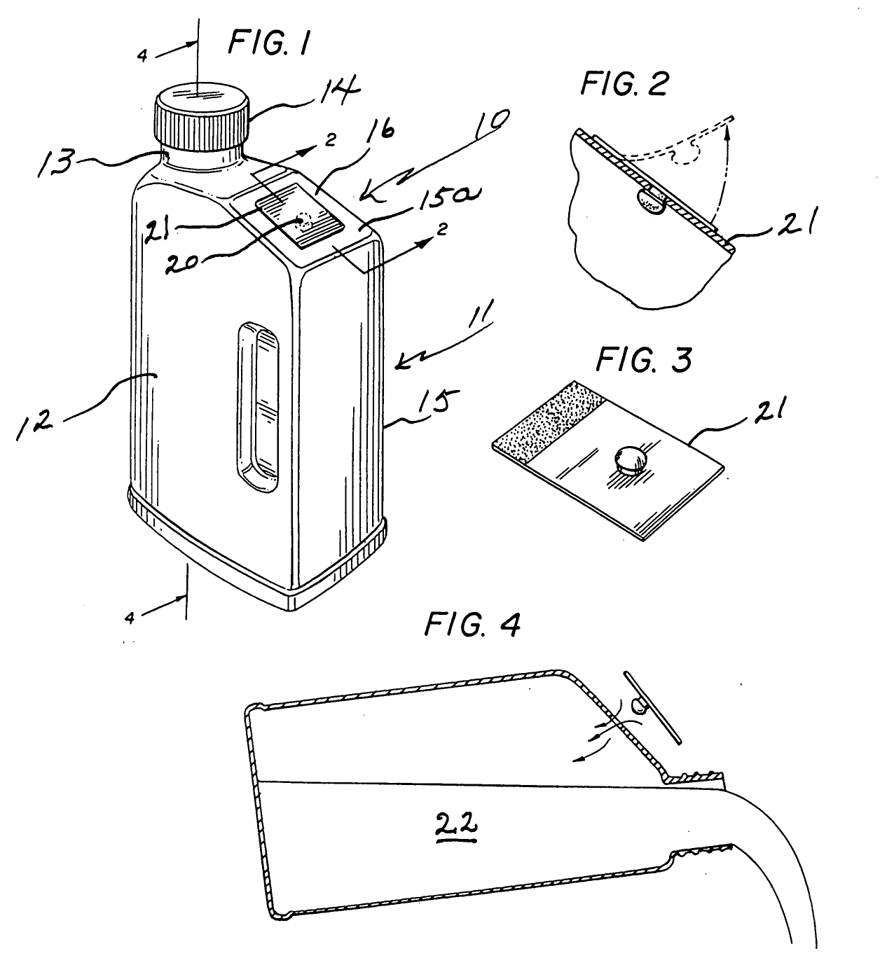

A first embodiment 10 of the invention is shown in FIGS. 1-4 and comprises a container 11, typically of blown or injection molded plastic, however the container could also be constructed of glass, metal, wax coated cardboard, etc.

The container 11 defines a body element 12, pouring spout 13, closure cap 14, hollow handle 15 defining an upper area 15a, and an upper inclined body portion 16. An air intake bore 20 is provided on the inclined body portion 16 adjacent the upper area handle portion 15a, and a closure element 21 is provided for the intake bore.

Use of the air intake bore 20 adjacent the upper area 15a of the hollow handle enables a smoother and more uniform pouring function than prior art containers. It has been found it is essential for the air entry bores of this invention to be coextensive with the upper inclined body portion 16 of the bottle. Also, for preferred pouring performance of liquid 22, the opening area of an air intake bore should be sized about 25%-35%, and preferably 30% of the pouring spout opening area.

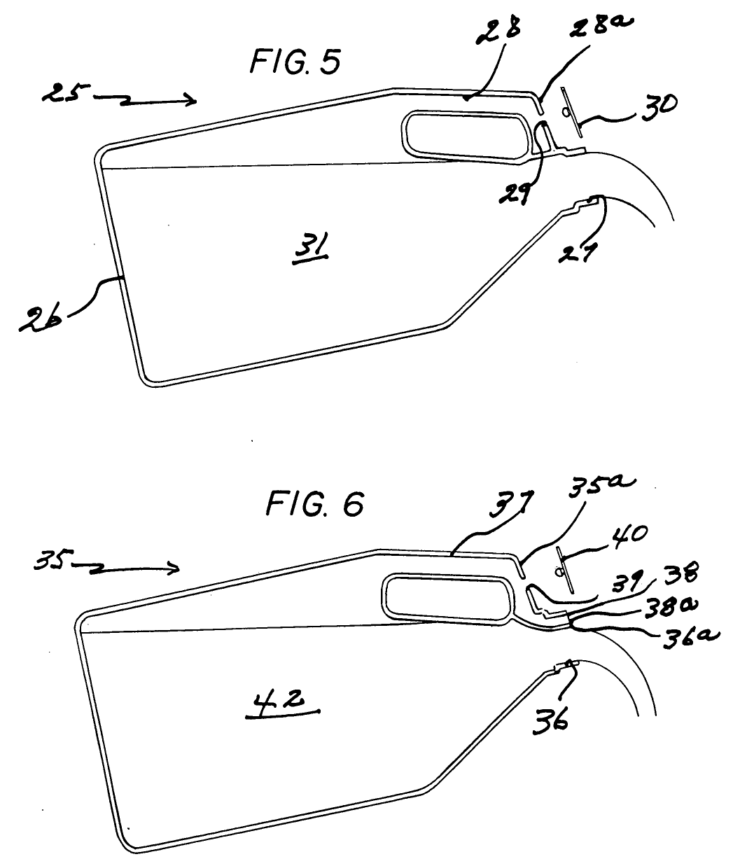

FIGS. 5 and 6 illustrate other, albeit similar embodiments of the invention, an air intake bore of each embodiment being coextensive with a hollow handle of the container.

In FIG. 5, a container 25 according to the invention defines a body portion 26, pouring spout exit 27, hollow handle 28 having an upper portion 28a, and an air entry bore 29 defined along the upper portion 28a and somewhat remote from spout exit 27. A closure element 30 similar to that shown in FIGS. 1-4 is provided for the air entry bore 29. It will be observed that pouring of liquid 31 is smooth and uniform.

In FIG. 6, a container 35 provides a pouring spout 36, hollow handle 37, and an air entry bore 38 is defined along the upper portion 35a of the container, and the entry 38a of bore 38 is adjacent to the spout exit 36a. If desired, a relief bore 39 is defined along the air entry bore 38 and a closure element 40 is provided for the relief bore. If desired, additional relief bores may be provided along the entry bore, and this also applies to the embodiment shown in FIG. 5. Similar to the case of FIG. 5, pouring of liquid 42 is smooth and uniform.

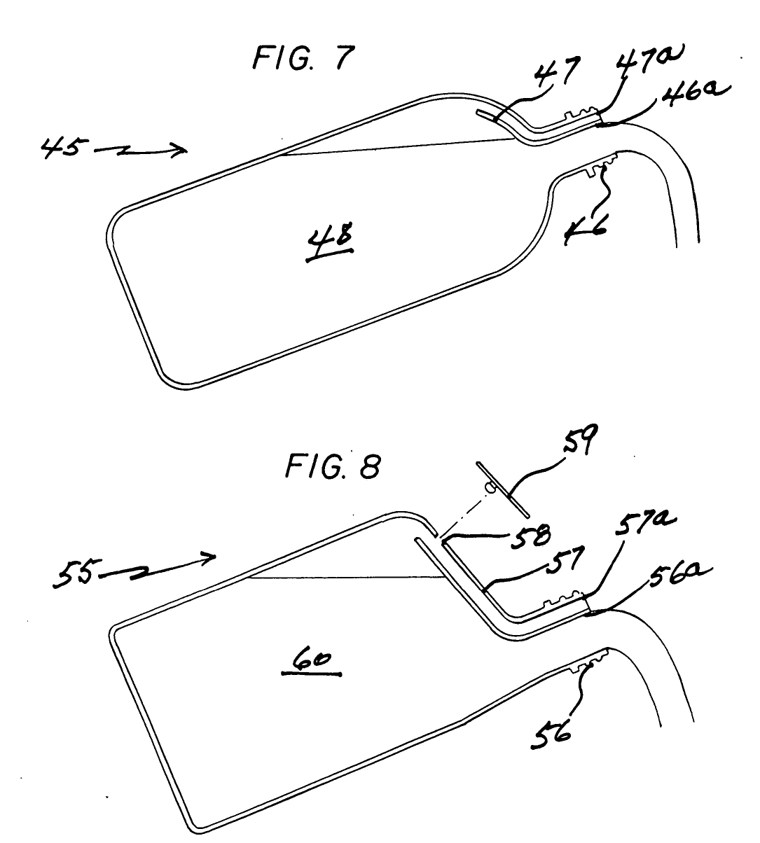

FIGS. 7 and 8 illustrate a container providing an air intake line having an entry immediately adjacent the exit of the pouring spout.

In FIG. 7, a container 45 is shown providing a pouring spout 46 and an air intake line 47, the inlet 47a of the intake line 47 being immediately adjacent the exit 46a of the pouring spout. This embodiment of the present invention is distinct from that shown in U.S. Pat. No. 4,838,464 showing an air intake line having an entry coextensive with the exit of the pouring spout. As shown, pouring of liquid 48 is smooth and regular.

In FIG. 8, a container 55 is shown providing a pouring spout 56 and an air intake line 57, the inlet 57a of the intake line 57 being immediately adjacent the exit 56a of the pouring spout. A relief bore 58 is defined near the end of the intake line and remote from the inlet 57a of the inlet line 57. If necessary, additional relief bores may be used. For some uses, the relief bore 58 and associated pull tab 59 may be eliminated. A closure element 59 is provided for the relief bore 58. Also, as shown in FIG. 7, pouring of liquid 60 is smooth and regular.

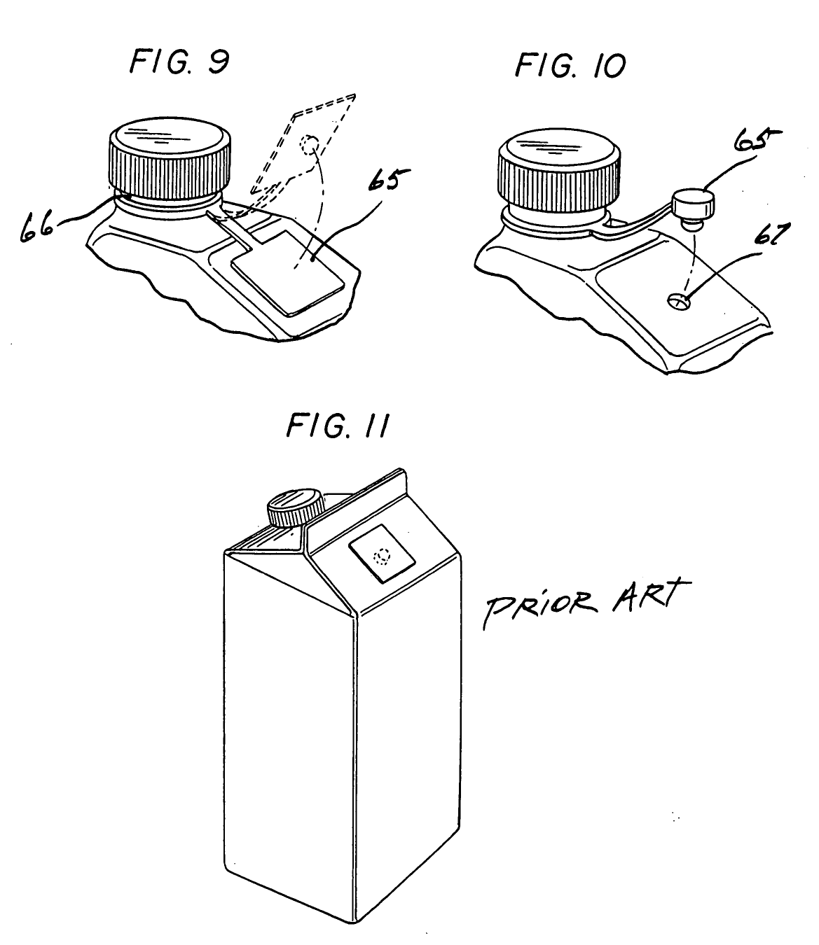

FIGS. 9 and 10 illustrate use of another embodiment of a closure element suitable for use with the embodiment shown in FIG. 1. In FIG. 9, a sealing closure 65 is shown movably attached to a pouring spout 66 for closure of a relief bore 67 shown in FIG. 10. The location of the relief bore adjacent the hollow handle 15 shown in FIG. 1 facilitates uniform and smooth flow of liquid from the container 11 of FIG. 1. The embodiments shown in FIGS. 1-4, 9 and 10 are distinct from FIG. 11, and shown in Japanese Patent JP 406,255,651 A, discussed, supra.

1. A flow control device for a container of liquid or viscous materials, the container consisting of:
a.) side walls, bottom, a top wall and a pouring spout for the liquid or viscous materials, the pouring spout defining an exit port; and,
b.) an air vent by-pass channel positioned coextensive with the top wall of the container, the by-pass channel extending into the container, an open relief valve defined by the top wall and adjacent the by-pass channel, an air entry port of the by-pass channel being positioned adjacent to and totally separated from the exit port of the pouring spout, and a terminal port being defined by the by-pass channel and disposed within the container and above the level of liquid or viscous material during a pouring operation, whereby positioning of the relief valve exposes the interior of the container to atmospheric, thereby immediately equalizing the pressure from within the container and atmospheric, and consequently enabling a continuous and uniform pouring of liquid or viscous material from the container.

2. The flow control device of claim 1, in which an air entry port of the by-pass channel defines an opening area about 25%-30% of an opening area of the pouring spout to provide a uniform and smooth pouring of liquid or viscous material from the container.

3-11. (canceled)
